(19) United States
(12) Patent Application Publication
(10) Pub. No.: US 2024/0286592 A1
(43) Pub. Date: Aug. 29, 2024

(54) VEHICLE WITH A RETARDER BRAKE DEVICE, AND CORRESPONDING BRAKING METHOD

(71) Applicant: MAN Truck & Bus SE, München (DE)

(72) Inventor: Alexander Schydlo, MÜNCHEN (DE)

(21) Appl. No.: 18/288,529

(22) PCT Filed: Apr. 14, 2022
(86) PCT No.: PCT/EP2022/060095

§ 371 Date: May 16, 2024

(30) Foreign Application Priority Data
Apr. 28, 2021 (DE) 10 2021 110 899.3

(51) Int. Cl. B60T 10/04; B60T 1/093

(52) U.S. Cl. CPC B60T 10/04; B60T 1/093

(57) ABSTRACT

A vehicle includes a continuous braking device. The continuous braking device includes a non-firing piston engine which can be drivingly coupled to a drive train shaft of the vehicle and is configured, during operation, for conveying air from an air inlet of the piston engine to an air outlet of the piston engine and for thereby compressing the air and for causing deceleration of the vehicle by performing compression work.

The invention relates to a vehicle comprising a continuous braking device and a method for braking a vehicle with such a continuous braking device.

Today's utility vehicles usually comprise wheel braking devices (e.g. in the form of drum or disc brakes) as well as at least one continuous braking device. The wheel braking devices, which are usually actuated by compressed air, are usually classic friction brakes that are not designed for continuous operation. A continuous braking process—which occurs, for example, during long downhill runs—would therefore, if wheel braking devices were used exclusively, cause them to heat up considerably, which would result in a reduction in the braking effect (fading) and, in extreme cases, in a failure of the braking devices.

In contrast, continuous braking devices are designed for longer periods of braking without any significant reduction in braking power. Engine brakes and/or retarders are usually used for this purpose in today's utility vehicles. Since the aforementioned continuous braking devices usually cannot stop the vehicle fully, corresponding vehicles are usually equipped with both wheel and continuous braking devices.

In the case of the aforementioned engine brakes as a continuous braking device, braking is achieved by dragging the unfired engine with the clutch closed and the gear engaged. In order to further increase the braking power, it is known to throttle the exhaust gas flow during the extension stroke with an exhaust flap installed in the exhaust pipe (exhaust brake). This exhaust flap, or throttle valve, is closed by the driver as required using compressed air so that the gas emitted from the engine is accumulated, and a back pressure is built up. The pistons then have to do additional work against this back pressure when the cylinder charge is pushed out and are thus slowed down, thus decelerating the vehicle as a whole.

An additional or alternative way of increasing the braking effect of the engine brake is to withdraw part of the energy stored in the compressed gas from the cylinder system by selective decompression during the compression stroke, which then cannot be converted back into the kinetic energy of the piston or crankshaft in the subsequent expansion stroke (decompression brake). The pressure in the cylinder can be reduced or decompressed by means of exhaust valves or separate valves (e.g. a constant throttle) in the cylinder head for this purpose. This type of engine brake is often colloquially referred to as “Jake Brake”.

A disadvantage of the aforementioned engine brakes, however, is that this type of continuous braking is not available in the case of purely electrically driven (commercial) vehicles, i.e. vehicles without a conventional combustion engine, because the corresponding structures (cylinders, valves, pistons, . . . ) are missing.

In addition to the engine brakes mentioned above as wear-free continuous braking devices, the use of retarders (braking machines) is also known in the state of the art. Retarders are installed in the vehicle's drive train (e.g. between engine and gearbox or between gearbox and drive axle) and are capable of converting part of the vehicle's kinetic energy into heat. Hydrodynamic and electro-dynamic retarders are usually used for this purpose, as described, for example, in “Nutzfahrzeugtechnik—Grundlagen, Systeme, Komponenten”, 7th edition, Vieweg 2013, p. 281 et seq. However, a disadvantage of using retarders as a braking system is the high energy dissipation and transformation into waste heat, which must be dissipated to the outside via the primary cooling system. Especially for purely electrically driven (commercial) vehicles, for which—as outlined above—no additional classic engine brake is available, the cooling surfaces for dissipating heat to the environment must therefore be dimensioned accordingly large (high space requirement). Otherwise, the maximum braking power of the retarder would be limited by the available radiator cooling surface.

Accordingly, it is the object of the invention to provide a continuous braking device for a vehicle, preferably a purely electrically driven vehicle, that avoids the disadvantages of the previous solutions. In particular, it is an object of the invention to provide a solution that allows for effective continuous braking of the vehicle with low thermal loads on its cooling system.

These objects can be solved with the features of the independent claims. Advantageous embodiments and applications of the invention are the subject of the dependent claims and are explained in more detail in the following description with partial reference to the figures.

The basic idea of the invention is to equip a vehicle with at least one piston brake that works according to the principle of an “engine brake” known from internal combustion engines without, however, being configured for firing or driving the vehicle. Although this solution requires the installation of an additional piston engine, it can provide a continuous braking device, which, compared to retarder solutions, results in lower thermal loads for the vehicle. This is due to the fact that in the case of “engine” or piston brakes, the working medium, i.e. the compressed cylinder gas, dissipates part of the dissipation energy directly to the environment (open cycle), whereas in the case of a classic retarder, the majority of the waste heat flow must first be transferred to a coolant and then to the environment.

According to a first independent solution, a vehicle is provided. Preferably, the vehicle is a utility vehicle, i.e. a vehicle that, by virtue of its construction and equipment, is specially designed for transporting persons, transporting goods or towing trailer vehicles. Furthermore, the claimed vehicle comprises a continuous braking device. In this context, a continuous braking device can be understood as a device of the vehicle that serves for continuous, preferably wear-free, braking of the vehicle. For this purpose, the continuous braking device comprises a non-firing piston engine (e.g. a non-firing reciprocating piston engine), which can be drivingly coupled to a drive train shaft of the vehicle. The term “non-firing” may indicate that the corresponding piston engine is not configured for firing with fuel (e.g. petrol) or for converting chemical energy stored in a fuel into mechanical work for the purpose of vehicle propulsion.

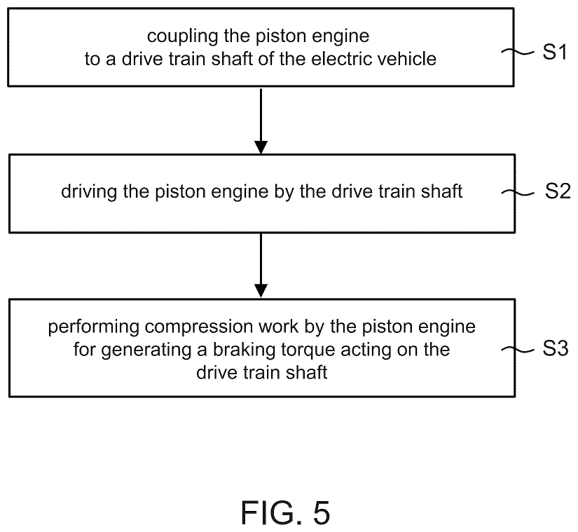

Furthermore, the piston engine is configured, during operation, for conveying air from an air inlet of the piston engine to an air outlet of the piston engine, thereby compressing the air and preferably causing deceleration of the vehicle by performing compression work. In other words, the aforementioned piston engine—which can also be called a compressor—may be understood as a device operating according to the principle of a known “engine brake” (decompression brake), with the difference that the piston engine is not an internal combustion engine normally used in this case. Since the discharged compressed air also dissipates part of the dissipation energy during compression to the outside (open cycle), advantageously less heat is introduced into the vehicle compared to a conventional retarder brake device, which will be described in more detail below in connection with FIG. 5.

According to one aspect of the invention, the piston engine is not an internal combustion engine and/or is not configured for propelling the vehicle. In other words, the piston engine may be configured as a solely driven machine and/or be operable solely for the purpose of continuous braking. Preferably, the piston engine has no fuel supply and no ignition device.

In addition or alternatively, the vehicle can be an electric vehicle. The term “electric vehicle” should be understood as a vehicle powered purely by electric energy (e.g. from a battery and/or fuel cell), which does not comprise any internal combustion engine for propulsion. Preferably, the vehicle is an electric utility vehicle (e.g. an electric truck).

According to a further aspect of the invention, the continuous braking device may comprise a throttle device (e.g. in the form of a pivotable throttle valve). In this context, a throttle device can be understood as a device that is configured for regulating, in particular for reducing, a (air) volume flow flowing through the throttle device. The throttle device may be arranged downstream of the air outlet of the piston engine. Furthermore, the throttle device may be configured for causing a braking back pressure at the air outlet of the piston engine by reducing the air flow rate. Advantageously, by this, the braking effect of the continuous braking device can be further increased—analogous to the way of operation of a known exhaust brakes.

According to a further aspect of the invention, the throttle device may comprise an adjustable throttle valve arranged in an outlet duct connected to the air outlet of the piston engine. Preferably, the throttle valve is, preferably continuously, movable between a closed position closing off the outlet duct and an open position opening the outlet duct. By way of example only, the throttle valve may be configured as a pivoting valve that can be pivoted continuously between a position parallel to the flow and a position approximately perpendicular to the flow. Advantageously, components already approved for use as exhaust gas flaps in engine brakes can be used.

In order to advantageously achieve a fast pressure build-up and, by this, avoid any delays in the braking process, according to a further aspect of the invention, the air inlet may be connected to a compressed air reservoir and/or to an outlet of an air compressor (e.g. a mechanically, electrically or hydraulically driven air compressor) via a connecting duct for supplying compressed air to the piston engine. The compressed air reservoir and/or the air compressor may preferably be part of an air suspension system and/or an air brake system for further wheel brake devices present in the vehicle. In other words, the air compressor may be an air compressor for filling an air suspension system and/or a compressed air brake system. By this, compressed air sources that are often already present in corresponding vehicles can be advantageously used to supply additional compressed air to the piston engine in order to shorten the time until the maximum back pressure or the maximum brake pressure is built up.

According to a further aspect of the invention, the air inlet may comprise an inlet valve for controlling the supply of air into the piston engine. The inlet valve may be operable via a valve train, which will be hereinafter referred to as “first” valve train for better differentiation. Furthermore, the air outlet may comprise an outlet valve for controlling the air discharge from the piston engine. The outlet valve may be operable via a “second” valve train.

According to a further aspect of the invention, the first valve train may be an electric, hydraulic, and/or pneumatic valve train. In addition or alternatively, the second valve train may also be an electric, hydraulic, and/or pneumatic valve train. This is particularly advantageous—especially in view of the fact that the piston engine used here is not an internal combustion engine used for propulsion—as the aforementioned valve trains (e.g. in the form of electric, hydraulic, and/or pneumatic actuators) generally offer a significantly larger or more variable adjustment range than mechanical valve drives (e.g. in the form of a camshaft). In principle, however, the first and/or second valve trains may also be mechanical valve trains.

Furthermore—in addition or alternatively—the first valve train and the second valve train may be operable independently of each other. For example, the first valve train may be configured as a first electro-hydraulic valve train, and the second valve train may be configured as a second electro-hydraulic valve train, each of which may be controlled independently. This advantageously enables flexible control of the corresponding valves. Alternatively, however, the inlet and outlet valves may be actuated separately by a common mechanism. In other words, the first and second valve trains may also be a common valve train (e.g. a camshaft).

According to a further aspect of the invention, the second valve train may be configured to permanently hold the exhaust valve in an intermediate open position. This can be easily realized, in particular, if the first and second valve trains are operable independently of each other (e.g. if they are configured as separate electro-hydraulic valve trains). In order to achieve continuous throttling, the piston engine may, in addition or alternatively, comprise a constant throttle valve actuatable via a third valve train. In this case, the third valve train may be configured for keeping the constant throttle valve permanently in an open position. Preferably, the constant throttle valve is configured as a bypass to the outlet valve.

According to a further aspect of the invention, the piston engine is not used for filling a compressed air brake system and/or an air suspension system of the vehicle. In other words, the piston engine is not a piston machine for filling a compressed air brake system of the vehicle and is not a piston engine for filling an air suspension system of the vehicle. For this purpose, the vehicle may—in addition or alternatively—comprise a respective air compressor for filling a compressed air brake system and/or an air suspension system. This may be predisposed, for example, when the piston brake is uncoupled during traction operation of the vehicle. In addition or alternatively, no compressed air-actuated consumer (e.g. a brake cylinder) and/or no compressed air consumer circuit may be connected to the piston engine on the outlet side.

Preferably, no compressed-air-actuated consumer for filling it with compressed air and/or no compressed-air consumer circuit for filling it with compressed air is connected to the piston engine on the outlet side. In addition or alternatively, the air compressed by the piston engine may be discharged to the atmosphere without further use. In other words, braking via the compression engine may be configured as an open circuit in which the compressed air supplied by the piston engine is discharged to the atmosphere essentially “unused”. In addition or alternatively, the air compressed by the piston engine may not be available as a medium, in particular not as a hot medium, for other processes.

According to a further aspect of the invention, the vehicle may comprise a coupling device (e.g. in the form of a friction clutch) configured for selectively drivingly coupling and decoupling the piston engine and the drive train shaft. In other words, the vehicle may comprise a coupling device arranged in a torque-transmitting path between the piston engine and the drive train shaft and configured to allow or interrupt the flow of torque into that path. Advantageously, the braking effect of the piston engine can thus be turned on or off as required.

According to a further aspect of the invention, the piston engine may be a single cylinder piston engine or a multicylinder piston engine. Preferably, the term “cylinder” refers to a tubular working space boundary of a reciprocating engine within which a piston is guided. In general, however, the term “cylinder” may refer to any working space boundary, i.e. not necessarily cylindrical. Furthermore, in the context of the present application, a “piston engine” may be understood as a fluid energy machine that serves to increase the potential energy of a fluid (here air) by supplying mechanical energy with the aid of a displacer (piston). This is usually done by intermittently changing the volume of a working chamber of the piston engine with a displacer (piston) that is usually moved periodically.

In order to advantageously achieve a high braking effect in all driving situations, the continuous braking device may further comprise at least one retarder. Preferably, the at least one retarder may be a hydrodynamic retarder (also called a flow brake) or an electro-dynamic retarder (also called an eddy current brake). Since the various wear-free continuous braking systems are based on different working principles and thus provide different braking power depending on the vehicle speed, by combining them, an advantageous combination of the respective braking effects can be achieved.

Furthermore, the invention relates to a method of braking, preferably continuous braking, a vehicle. The vehicle, preferably an electric utility vehicle, may be configured as described in this document. In other words, all aspects described in connection with the vehicle are also disclosed and claimable in connection with the method.

In particular, the corresponding vehicle may comprise a continuous braking device with a non-firing piston engine, wherein the piston engine can be drivingly coupled to a drive train shaft of the vehicle and is configured, during operation, for conveying air from an air inlet of the piston engine to an air outlet of the piston engine and for thereby compressing the air and for causing deceleration of the vehicle by performing compression work.

The method comprises the step of coupling the piston engine to a drive train shaft of the vehicle. This can be done, for example, by closing a coupling device arranged in the torque-transmitting path between the piston engine and the drive train shaft. Further, the method comprises the step of driving the piston engine by the drive train shaft. In other words, mechanical work may be supplied to the piston engine for its operation. Preferably, a drive on the vehicle side of the drive train shaft is interrupted and/or a drive used for propulsion of the vehicle (e.g. an internal combustion engine or an electric motor) is switched off. Further, the method comprises the step of performing compression work by the piston engine for generating a braking torque acting on the drive train shaft. In other words, the piston engine may be understood as a machine operated according to the known principle of an “engine brake” (decompression brake), with the difference that the piston engine is not an internal combustion engine normally used in this process. Since the discharged compressed air also dissipates part of the dissipation energy to the outside during compression, advantageously less heat is introduced into the vehicle than this is the case with conventional retarder braking devices.

In accordance with an aspect of the invention, in case that the aforementioned continuous braking device of the vehicle comprises a throttle device arranged downstream of the air outlet of the piston engine, configured for causing a braking back pressure at the air outlet of the piston engine by reducing the air flow rate, the method may further comprise the step of: throttling the air flow rate by means of the throttle device to build up a braking back pressure. For example, in the case where the throttle device comprises a throttle valve, the throttling may be accomplished by closing the throttle valve or moving the throttle valve to the closed position.

Since the piston engine must additionally work against the back pressure when pushing out the compressed air, the braking effect of the continuous braking device may advantageously be further increased—analogous to the operating principle of a known exhaust brake. Finally, with regard to this aspect, it should be mentioned that in addition to the aforementioned throttle device, the vehicle may optionally also comprise further limitations mentioned in this document. According to a further aspect of the invention, in case that the air inlet of the piston engine is connected to a compressed air reservoir and/or an outlet of an air compressor via a connecting duct, the method may further comprise the step of: supplying compressed air from the compressed air reservoir and/or from the outlet of the air compressor to the piston engine at the beginning of a braking process. Advantageously, this may result in a rapid (back-)pressure build-up in the continuous braking device, effectively avoiding delays at the beginning of the braking process. It should also be mentioned as a precautionary measure that, in addition to the aforementioned features, the vehicle may optionally include further limitations mentioned in this document.

The aspects and features of the invention described above can be combined in any way. Further details and advantages of the invention are described below with reference to the figures, showing:

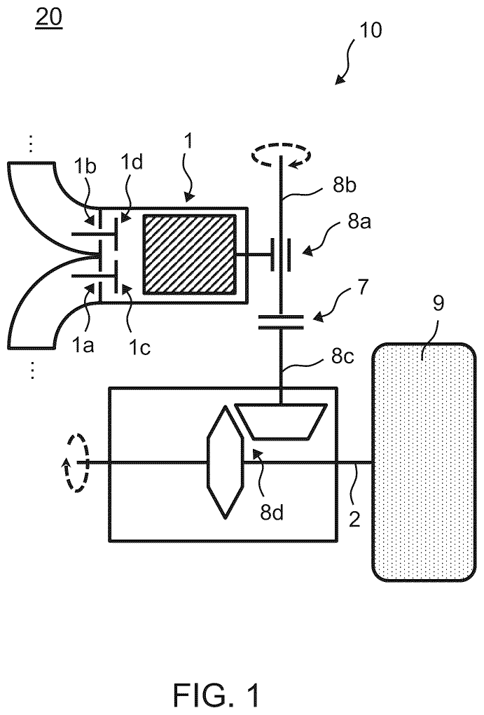

FIG. 1: a schematic representation of a continuous braking device for a vehicle according to a first embodiment of the invention;

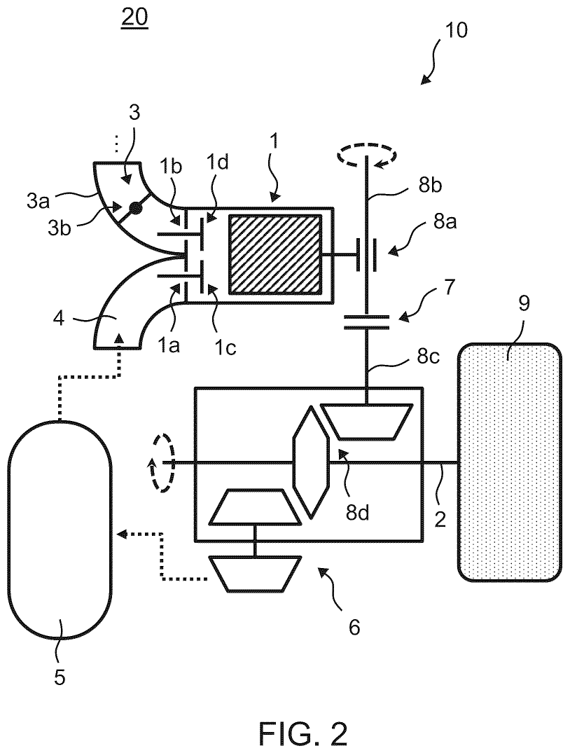

FIG. 2: a schematic representation of a continuous braking device for a vehicle according to a second embodiment of the invention;

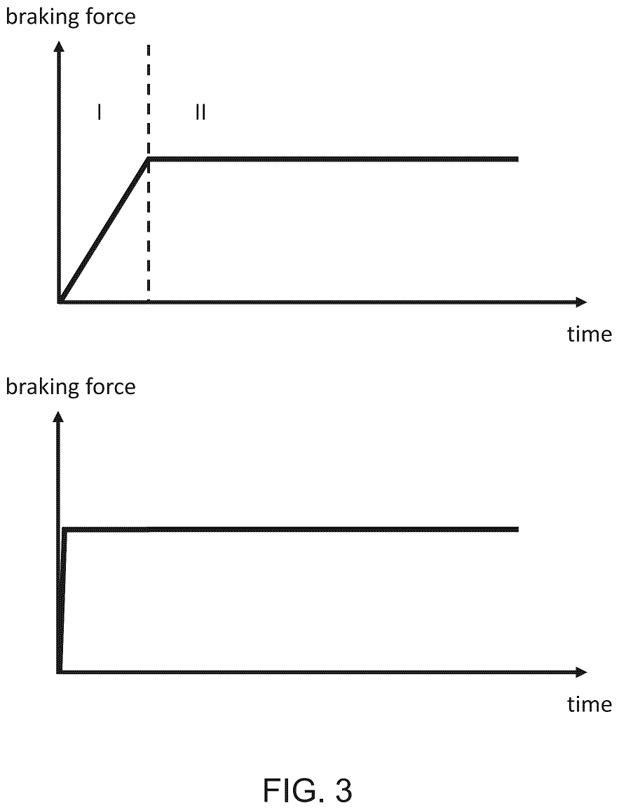

FIG. 3: a schematic representation of a braking force curve over time of the continuous braking device of the second embodiment with and without additional compressed air supply;

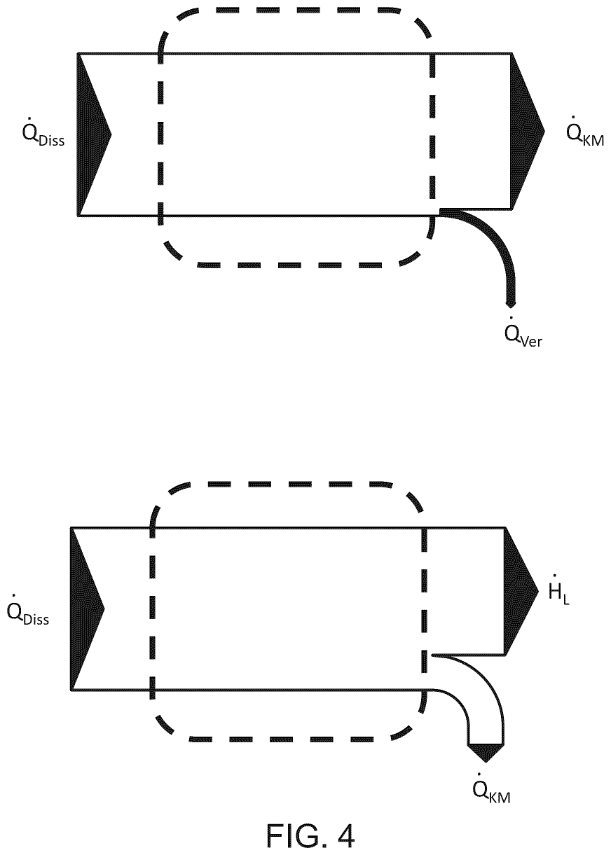

FIG. 4: a schematic comparison of the energy flows during continuous braking by means of retarder and motor brake in the form of Sankey diagrams; and

FIG. 5: a flowchart of a method of braking a vehicle according to an embodiment of the invention.

Identical or functionally equivalent elements are described in all figures with the same reference signs and are not described separately.

FIG. 1 shows a schematic representation of a continuous braking device 10 of a vehicle 20 (not shown) according to a first embodiment. The continuous braking system 10 comprises a non-firing piston engine 1, which is configured as a non-firing reciprocating piston engine by way of example only. In general, however, the piston engine 1 may also be configured in the form of another type of reciprocating machine known in the prior art, whereby the term “reciprocating machine” may generally denote a fluid energy machine with a working chamber, the volume of which is intermittently changed by a usually periodically moved displacer (piston).

The piston engine 1 can be drivingly coupled to a drive train shaft 2 of the vehicle 20. The term “drivingly” may in general indicate that the coupling is for the purpose of driving the piston engine 1. That is, in other words, that the piston engine 1 is intended to be drivable by a movement of the drive train shaft 2 by being coupled to the drive train shaft 2 (e.g. by means of known techniques such as gears, belts, clutches, shafts, etc.). In the present case, the piston engine 1 may be coupled—by way of example only—via a crankshaft 8a, two shafts 8b and 8c connected via a coupling device 7, and a gearbox 8d to the drive train shaft 2, which may be, for example, a wheel shaft of a rear wheel 9.

The piston engine 1 is further configured for, during operation, conveying air from an air inlet 1a of the piston engine 10—which can be opened or closed by means of an inlet valve 1c—to an air outlet 1b of the piston engine 1—which can be opened or closed by means of an outlet valve 1d—and for compressing the air in the process. This can be done, for example, by a corresponding—known in the prior art—control of the inlet valve 1c and outlet valve 1d. Preferably, the piston engine 1 is further configured for causing deceleration of the vehicle 20 by performing compression work. In this context, the term “air” may generally refer to a compressible, gaseous working medium, preferably ambient air, i.e. the gas mixture of the earth's atmosphere. By coupling the piston engine 1 to the drive train shaft 2, at least part of the kinetic energy of the vehicle 20 can be extracted by the piston engine 1 performing compression work—analogous to the operating principle of an engine brake.

FIG. 2 shows a schematic representation of a continuous braking device 10 of a vehicle 20 (not shown) according to a second embodiment. In contrast to the embodiment shown in FIG. 1, the continuous braking device 10 shown here comprises a throttle device 3 arranged downstream of the air outlet 1b of the piston engine 1. The throttle device 3 is configured for building up a braking back pressure at the air outlet 1b of the piston engine 1 by reducing the air flow rate. By way of example only, the throttle device 3 may comprise a pivotable throttle valve 3b arranged in an outlet duct 3a connected to the air outlet 1b of the piston engine 1, wherein the throttle valve 3b may be moved between a closed position closing the outlet duct 3a and an open position opening the outlet duct 3a. Advantageously, the braking effect of the continuous braking device 10 can thus be further increased—analogously to the mode of operation of a known exhaust brake.

In order to achieve a rapid pressure build-up, in particular at the start of a braking process, and thus to avoid delays in the braking process, the air inlet 1a of the piston engine 1 may also be connected via a connecting duct 4 to a compressed air reservoir 5 and/or an outlet of an air compressor 6 (only indicated schematically) for supplying compressed air. The compressed air reservoir 5 and/or the air compressor 6 can, for example, be part of an air suspension system and/or a compressed air brake system that are usually already present in utility vehicles. As will be described in more detail below with reference to FIG. 3, this connection advantageously enables additional pressure to be built up by supplying compressed air to the piston engine 1.

FIG. 3 shows a schematic representation of the braking force curve over time of the aforementioned continuous braking device 10 without (top) and with (bottom) additional compressed air supply through the compressed air reservoir 5 or air compressor 6. In the case shown above, in which the back pressure build-up takes place solely through the expulsion of air by the piston engine 1 against the throttle device 3, the system requires the time period marked “I” until the maximum achievable operating (back)pressure and thus the maximum braking force is available at the continuous braking device 10. Once the pressure has been built up, a deceleration with the maximum achievable braking force of the continuous braking device 10 can take place in the further braking operation (“time period II”).

In the case shown below, in which the build-up of back pressure is carried out not only by the piston engine 1 pushing out but also by supplying “additional” compressed air to the continuous braking device 10 or to the piston engine 1, the aforementioned pressure build-up phase I can be significantly shortened in an advantageous manner, and thus a braking delay at the beginning of the braking process can be effectively avoided. For an appropriate supply of compressed air to the piston engine 1, its air inlet 1a can be connected via a connecting duct 4, e.g. to a compressed air reservoir 5 and/or an outlet of an air compressor 6. The latter components are often already present in corresponding utility vehicles for filling an air suspension system and/or compressed air brake system, and can thus be used in an advantageous manner without the installation of additional components for the configuration of the corresponding pressure build-up function.

FIG. 4 shows a schematic comparison of the energy flows during continuous braking using a retarder (top) and a motor brake (bottom) in the form of Sankey diagrams. In the case of the retarder shown above, the dissipation energy \dot{Q}_{Diss} occurring during braking is—despite a small amount of loss \dot{Q}_{Ver}—mainly converted into heat \dot{Q}_{KM} that, in order to avoid overheating, must be dissipated to the outside via the coolant of the vehicle's cooling system. In contrast, in the case of the known engine brake shown below, there is a significantly lower heat input into the cooling system (\dot{Q}_{KM}), while the majority of the dissipation energy \dot{Q}_{Diss} is dissipated directly to the outside in the form of an increased gas enthalpy \dot{H}_{L} of the (compressed) discharged compressed air. Accordingly, the overall thermal load on the vehicle can be reduced in an advantageous manner by using a continuous braking device operating on the principle of the “engine brake”, compared to known retarder solutions.

FIG. 5 shows a flow chart of a method of braking a vehicle 20 according to one embodiment of the invention. The vehicle 20 is to be configured as described in this document, i.e. in particular comprise a continuous braking device 10 which comprises a piston engine 1 (e.g. a reciprocating piston engine). Furthermore, the piston engine 1 is capable of being drivingly coupled to a drive train shaft 2 of the vehicle 20 and is configured, in operation, for conveying air from an air inlet 1a of the piston engine 1 to an air outlet 1b of the piston engine 1 and, in doing so, compressing the air and preferably causing deceleration of the vehicle 20 by performing compression work. In this context, the method comprises, in step S1, coupling the piston engine 1 to a drive train shaft 2 of the vehicle 20. This can be done, for example, using known coupling and/or connection techniques (including, for example, disk couplings, cardan shafts, bevel gears, etc.). In step S2, the piston engine 1 is then driven by means of the drive train shaft 2. In other words, energy can be supplied to the piston engine 1 in the form of mechanical work. This is used in step S3 to perform compression work by means of the piston engine 1 to generate a braking torque acting on the drive train shaft 2. To increase the braking effect, it is further advantageous if the aforementioned continuous braking device 10 of the vehicle 20 comprises a throttle device 3. In this case, the method may further comprise throttling the air flow by the throttle device 3 to build up a braking back pressure. Furthermore, in the event that the air inlet 1a of the piston engine 1 is connected to a compressed air reservoir 5 and/or an outlet of an air compressor 6 via a connecting duct 4, the method may further comprise supplying compressed air from the compressed air reservoir 5 and/or the outlet of the air compressor 6 to the piston engine 1 at the beginning of a braking process.

Although the invention has been described with reference to specific embodiments, it is apparent to one skilled in the art that various modifications may be configured and equivalents may be used as substitutes without departing from the portion of the invention. Consequently, the invention is not intended to be limited to the disclosed embodiments, but is intended to encompass all embodiments falling within the portion of the appended claims. In particular, the invention also claims protection for the subject-matter and features of the sub-claims independently of the claims referred to.

### LIST OF REFERENCE SIGNS

1 piston engine
1a air inlet
1b air outlet
1c inlet valve
1d outlet valve
2 drive train shaft
3 throttle device
3a outlet duct
3b throttle valve
4 connecting duct
5 compressed air reservoir
6 air compressor
7 coupling device
8a crankshaft
8b, 8c shaft
8d gearbox
9 rear wheel
10 continuous braking device
20 vehicle

1. A vehicle, comprising:
a continuous braking device, wherein the continuous braking device comprises a non-firing piston engine, which can be drivingly coupled to a drive train shaft of the vehicle and which is configured, during operation, for conveying air from an air inlet of the piston engine to an air outlet of the piston engine and for thereby compressing the air and for causing deceleration of the vehicle by performing compression work.

2. The vehicle according to claim 1, wherein
a) the piston engine is not an internal combustion engine and/or is not configured for propelling of the vehicle or
b) the vehicle (20) is an electric vehicle.

3. The vehicle according to claim 1, wherein the continuous braking device comprises a throttle device arranged downstream of the air outlet of the piston engine and configured for causing a braking back pressure at the air outlet of the piston engine (1) by reducing the air flow rate.

4. The vehicle according to claim 3, wherein the throttle device comprises an adjustable throttle valve arranged in an outlet duct connected to the air outlet of the piston engine, wherein the throttle valve is movable between a closed position closing off the outlet duct and an open position opening the outlet duct.

5. The vehicle according to claim 3, wherein, for supplying compressed air to the piston engine, the air inlet is connected to a compressed air reservoir or to an outlet of an air compressor via a connecting duct.

6. The vehicle according to claim 1, wherein,
a) the air inlet comprises an inlet valve for controlling the supply of air into the piston engine, the inlet valve being operable via a first valve train; and
b) the air outlet comprises an outlet valve for controlling the air discharge from the piston engine, the outlet valve being operable via a second valve train.

7. The vehicle according to a claim 6, wherein,
a) the first valve train is an electric, hydraulic, or pneumatic valve train; or
b) the second valve train is an electric, hydraulic, or pneumatic valve train; or
c) the first valve train and the second valve train are operable independently of each other.

8. The vehicle according to claim 6, wherein,
a) the second valve train is configured for permanently holding the outlet valve in an intermediate open position; or
b) the piston engine comprises a constant throttle valve actuatable via a third valve train, the third valve train being configured for keeping the constant throttle valve permanently in an open position.

9. The vehicle according to claim 1, wherein,
a) the piston engine is not used for filling a compressed air brake system and an air suspension system of the vehicle; or
b) no compressed air-actuated consumer and no compressed air consumer circuit is connected to the piston engine on the outlet side; or
c) the air compressed by the piston engine (1) is discharged to the atmosphere without further use.

10. The vehicle according to claim 1, wherein the vehicle comprises a coupling device configured for selectively drivingly coupling and decoupling the piston engine and the drive train shaft.

11. The vehicle according to one claim 1, wherein the piston engine is a single-cylinder piston engine or a multicylinder piston engine.

12. The vehicle according to claim 1, wherein,
the continuous braking device comprises a retarder; or
the continuous braking device comprises a hydrodynamic retarget; or
the continuous braking device comprises an electro-dynamic retarder.

13. A method of braking, a vehicle, comprising:
coupling a non-firing piston engine of a continuous braking device to a drive train shaft of a vehicle;
driving the piston engine by the drive train shaft; and
performing compression work by the piston engine for generating a braking torque acting on the drive train shaft.

14. The method of braking a vehicle according to claim 13, further comprising:
conveying air from an air inlet of the piston engine to an air outlet of the piston engine;
throttling the air flow by means of a throttle device arranged downstream of the air outlet of the piston engine to build up a braking back pressure at the air outlet of the piston engine.

15. The method of braking a vehicle according to claim 14, further comprising:
supplying compressed air to the air inlet of the piston engine from a compressed air reservoir or from an outlet of an air compressor to the piston engine at a beginning of a braking process.
